(19) United States
(12) Patent Application Publication
(10) Pub. No.: US 2021/0216051 A1
(43) Pub. Date: Jul. 15, 2021

(54) APPARATUS UNIT

(71) Applicant: KAWASAKI JUKOGYO KABUSHIKI KAISHA, Kobe-shi, Hyogo (JP)

(72) Inventors: Akihiro KONDO, Kobe-shi (JP); Ryuji SAKAI, Kakogawa-shi (JP); Hideyasu MURAOKA, Akashi-shi (JP)

(73) Assignee: KAWASAKI JUKOGYO KABUSHIKI KAISHA, Kobe-shi, Hyogo (JP)

(21) Appl. No.: 15/734,161

(22) PCT Filed: May 28, 2019
(86) PCT No.: PCT/JP2019/020995

§ 371 Date: Dec. 1, 2020

(30) Foreign Application Priority Data
Jun. 1, 2018 (JP) 2018-106042

(51) Int. Cl. G05B 15/02; G06K 19/06; G06K 7/14; F04B 49/06; F04B 53/10

(52) U.S. Cl. CPC G05B 15/02; G06K 19/06028; G06K 19/06037; F04B 53/10; G06K 7/1417; F04B 49/06; G06K 7/1413

(57) ABSTRACT

An apparatus unit includes two or more apparatuses coupled to each other, the apparatuses including respective casings that are independent of each other. Two or more storage media are attached to one side surface of the casing of one of the two or more apparatuses such that the two or more storage media are adjacent to each other, the two or more storage media each storing characteristic data of a corresponding one of the two or more apparatuses or storing an IP address of a save location of the characteristic data of the corresponding one of the two or more apparatuses.

### TECHNICAL FIELD

The present invention relates to an apparatus unit including two or more apparatuses that are coupled to each other.

### BACKGROUND ART

For example, FIG. 3 of Patent Literature 1 discloses an apparatus (a valve apparatus) that includes a single casing with three proportional solenoid valves incorporated therein. A storage medium is attached to a side surface of the casing of the apparatus. Characteristic data (a relationship between a command current and an output pressure) of each of the three proportional solenoid valves is stored on the storage medium in the form of a bar code.

In the case of adopting this configuration, even if the characteristics of the proportional solenoid valves vary from each other, the variation in characteristics among the proportional solenoid valves can be electronically calibrated by reading the characteristic data stored on the storage medium by a reading device (e.g., a bar code reader) and inputting the read characteristic data to a controller that feeds the command current to these proportional solenoid valves.

### CITATION LIST

### Patent Literature

PTL 1: Japanese Laid-Open Patent Application Publication No. 2006-114525

### SUMMARY OF INVENTION

### Technical Problem

However, in the case of configuring an apparatus unit by coupling two or more apparatuses to each other, the problem is how each storage medium that stores the characteristic data of a corresponding one of the apparatuses should be attached to the apparatus unit. It should be noted that, instead of storing the characteristic data on the storage medium, the characteristic data can be saved in, for example, a server or a terminal, and the IP (Internet Protocol) address of the save location of the characteristic data can be stored on the storage medium.

In view of the above, an object of the present invention is to provide an apparatus unit that makes it possible to efficiently read the characteristic data of two or more apparatuses.

### Solution to Problem

In order to solve the above-described problems, an apparatus unit according to the present invention includes two or more apparatuses coupled to each other. The apparatuses include respective casings that are independent of each other. Two or more storage media are attached to one side surface of the casing of one of the two or more apparatuses such that the two or more storage media are adjacent to each other, the two or more storage media each storing characteristic data of a corresponding one of the two or more apparatuses or storing an IP address of a save location of the characteristic data of the corresponding one of the two or more apparatuses.

According to the above configuration, in a case where each storage medium stores the characteristic data of the corresponding apparatus, the characteristic data of the two or more apparatuses can be read directly, whereas in a case where each storage medium stores the IP address of the save location of the characteristic data of the corresponding apparatus, the characteristic data of the two or more apparatuses can be read via the Internet. In addition, since these storage media are attached to one side surface of the casing of one of the apparatuses such that these storage media are adjacent to each other, the characteristic data of the two or more apparatuses can be read efficiently within a short period of time.

For example, each of the two or more apparatuses may be a pump whose delivery flow rate changes in accordance with a command current, and the characteristic data of each apparatus may be a relationship between the command current and the delivery flow rate at a particular delivery pressure.

The particular delivery pressure may be each of two different delivery pressures. This configuration makes it possible to perform calibration in accordance with the delivery pressure of the pump.

Alternatively, each of the two or more apparatuses may be a multi-control valve that incorporates therein a plurality of spools, each of which changes a passing flow rate thereof in accordance with a command current. The characteristic data of each apparatus may be relationships between the command current and the passing flow rates of the plurality of respective spools.

Each of the two or more storage media may further store a date of measurement of the characteristic data of the corresponding apparatus in a visually recognizable manner. When the apparatus is repaired (e.g., when a component of the apparatus is replaced), the characteristic data of the apparatus is re-measured. The date of the re-measurement is stored on the corresponding storage medium in a visually recognizable manner. Therefore, the user can recognize the repair history of the apparatus by looking at the storage medium. This improves the maintainability at a work site.

The two or more storage media may be integrated together. According to this configuration, a single object can be used as the two or more storage media.

### Advantageous Effects of Invention

The present invention makes it possible to efficiently read the characteristic data of two or more apparatuses.

### BRIEF DESCRIPTION OF DRAWINGS

FIG. 1 is a side view of an apparatus unit according to Embodiment 1 of the present invention.

FIG. 2 is a graph showing characteristic data of an apparatus in Embodiment 1.

FIG. 3 is a perspective view of an apparatus unit according to Embodiment 2 of the present invention.

FIG. 4 is a graph showing characteristic data of an apparatus in Embodiment 2.

FIG. 5 shows a hydraulic circuit of the apparatus unit according to Embodiment 2.

### DESCRIPTION OF EMBODIMENTS

### Embodiment 1

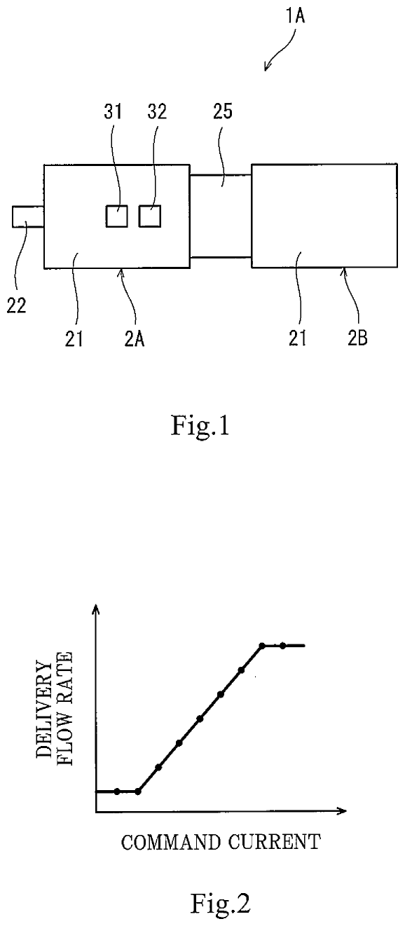

FIG. 1 shows an apparatus unit 1A according to Embodiment 1 of the present invention. The apparatus unit 1A includes a first apparatus 2A and a second apparatus 2B, which are coupled to each other. Alternatively, the apparatus unit 1A may include three or more apparatuses coupled to each other.

In the present embodiment, each of the first apparatus 2A and the second apparatus 2B is a variable displacement swash plate pump whose delivery flow rate changes in accordance with a command current. Alternatively, each of the first apparatus 2A and the second apparatus 2B may be a bent axis pump.

Specifically, the first apparatus 2A and the second apparatus 2B include their respective casings 21, which are independent of each other. Each casing 21 is, for example, a hexahedron having six side surfaces. One side surface of the casing 21 of the first apparatus 2A and one side surface of the casing 21 of the second apparatus 2B face each other with a middle casing 25 positioned therebetween.

Although not illustrated, a cylinder fixed to a rotating shaft 22, a plurality of pistons held by the cylinder, and a swash plate that slides on chutes mounted to the distal ends of the respective pistons are disposed in the casing 21 of the first apparatus 2A.

Similarly, a cylinder fixed to a rotating shaft (not shown), a plurality of pistons held by the cylinder, and a swash plate that slides on chutes mounted to the distal ends of the respective pistons are disposed in the casing 21 of the second apparatus 2B. The rotating shaft of the second apparatus 2B is coupled to the rotating shaft 22 of the first apparatus 2A in the middle casing 25.

Each of the casing 21 of the first apparatus 2A and the casing 21 of the second apparatus 2B incorporates therein a servo mechanism that changes, in accordance with the command current, the angle of the swash plate relative to a plane that is orthogonal to the center line of the rotating shaft. For example, the servo mechanism may be configured to electrically change hydraulic pressure applied to a servo piston coupled to the swash plate, or may include an electric actuator coupled to the swash plate.

A first storage medium 31 and a second storage medium 32 are attached to one side surface of the casing 21 of the first apparatus 2A, such that the first storage medium 31 and the second storage medium 32 are adjacent to each other. Alternatively, the first storage medium 31 and the second storage medium 32 may be attached to one side surface of the casing 21 of the second apparatus 2B, such that the first storage medium 31 and the second storage medium 32 are adjacent to each other.

In the present embodiment, characteristic data of the first apparatus 2A is stored on the first storage medium 31 in the form of a bar code, and characteristic data of the second apparatus 2B is stored on the second storage medium 32 in the form of a bar code. For example, the bar code is a matrix two-dimensional code (QR code (registered trademark)).

In the present embodiment, the first storage medium 31 and the second storage medium 32 are separate from each other. Alternatively, the first storage medium 31 and the second storage medium 32 may be integrated together. In this case, a single object can be used as the two storage media 31 and 32.

Each of the first storage medium 31 and the second storage medium 32 may be attached to the casing 21, for example, by affixing using an adhesive or a double sided tape, or by screw fixing.

As shown in FIG. 2, the characteristic data of each of the first apparatus 2A and the second apparatus 2B is a relationship between the command current and the delivery flow rate at a particular delivery pressure. The characteristic data is discrete data as represented by a plurality of points in FIG. 2, and the characteristic data of each apparatus (2A or 2B) is measured at a factory before its shipping from the factory. Also, when the apparatus is repaired (e.g., when a component of the apparatus is replaced), the characteristic data of the apparatus is re-measured.

Each of the first storage medium 31 and the second storage medium 32 further stores the date of the measurement of the characteristic data of the corresponding apparatus (2A or 2B) in a visually recognizable manner. Each of the first storage medium 31 and the second storage medium 32 further stores identification data (individual product number) of the corresponding apparatus (2A or 2B).

Each of the first apparatus 2A and the second apparatus 2B is a pump, and the characteristics of the pump vary in accordance with the delivery pressure of the pump. Accordingly, in the present embodiment, the aforementioned particular delivery pressure is each of two different delivery pressures. Specifically, the characteristic data of the first apparatus 2A, which is stored on the first storage medium 31, contains a relationship between the command current and the delivery flow rate at a relatively low first delivery pressure (e.g., 8 MPa) and a relationship between the command current and the delivery flow rate at a relatively high second delivery pressure (e.g., 15 MPa). Similarly, the characteristic data of the second apparatus 2B, which is stored on the second storage medium 32, contains a relationship between the command current and the delivery flow rate at a relatively low first delivery pressure (e.g., 8 MPa) and a relationship between the command current and the delivery flow rate at a relatively high second delivery pressure (e.g., 15 MPa). Alternatively, the characteristic data stored on each of the first storage medium 31 and the second storage medium 32 may be a relationship between the command current and the delivery flow rate only at one delivery pressure.

The apparatus unit 1A is installed, for example, in a construction machine (e.g., a hydraulic excavator or a hydraulic crane) or in an industrial machine. The first apparatus 2A and the second apparatus 2B are controlled by a controller of the machine. For example, the controller feeds the command current to each of the first apparatus 2A and the second apparatus 2B in accordance with an operation amount of an operation device operated by a user.

The characteristic data of the first apparatus 2A, which is stored on the first storage medium 31, and the characteristic data of the second apparatus 2B, which is stored on the second storage medium 32, are read by a bar code reader and inputted to the aforementioned controller of the machine. The controller electronically calibrates variation in characteristics between the first apparatus 2A and the second apparatus 2B. For example, the controller adjusts the command current fed to each of the first apparatus 2A and the second apparatus 2B so that a preset delivery flow rate corresponding to an operation amount of the operation device operated by the user will be obtained.

As described above, in the apparatus unit 1A of the present embodiment, the characteristic data of the first apparatus 2A is stored on the first storage medium 31, and the characteristic data of the second apparatus 2B is stored on the second storage medium 32. Therefore, the characteristic data of the first apparatus 2A and the characteristic data of the second apparatus 2B can be read directly. In addition, since the first storage medium 31 and the second storage medium 32 are attached to one side surface of the casing of the first apparatus 2A such that the first storage medium 31 and the second storage medium 32 are adjacent to each other, the characteristic data of the first apparatus 2A and the characteristic data of the second apparatus 2B can be read efficiently within a short period of time.

Moreover, in the present embodiment, the characteristic data stored on each storage medium (31 or 32) is a relationship between the command current and the delivery flow rate at two different delivery pressures. This makes it possible to perform the calibration in accordance with the delivery pressure of the pump.

Furthermore, in the present embodiment, each storage medium (31 or 32) stores the date of the measurement of the characteristic data of the corresponding apparatus (2A or 2B) in a visually recognizable manner. Therefore, the user can recognize the repair history of the apparatus by looking at the storage medium. This improves the maintainability at a work site.

### Embodiment 2

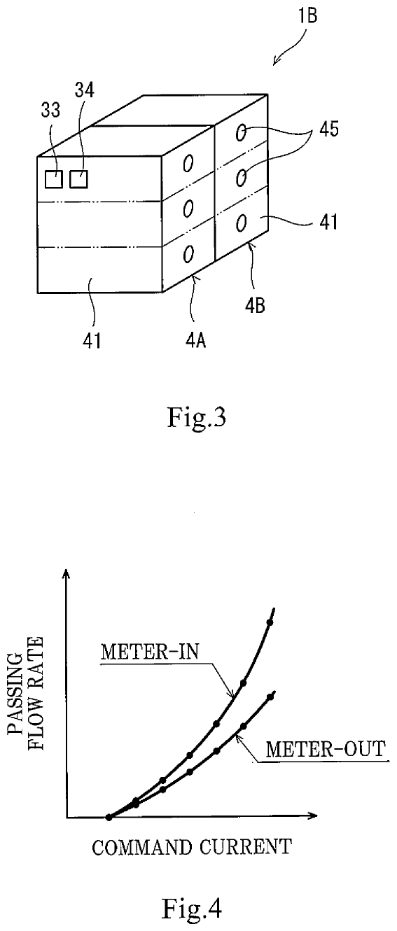

FIG. 3 shows an apparatus unit 1B according to Embodiment 2 of the present invention. The apparatus unit 1B includes a first apparatus 4A and a second apparatus 4B, which are coupled to each other. Alternatively, the apparatus unit 1B may include three or more apparatuses coupled to each other.

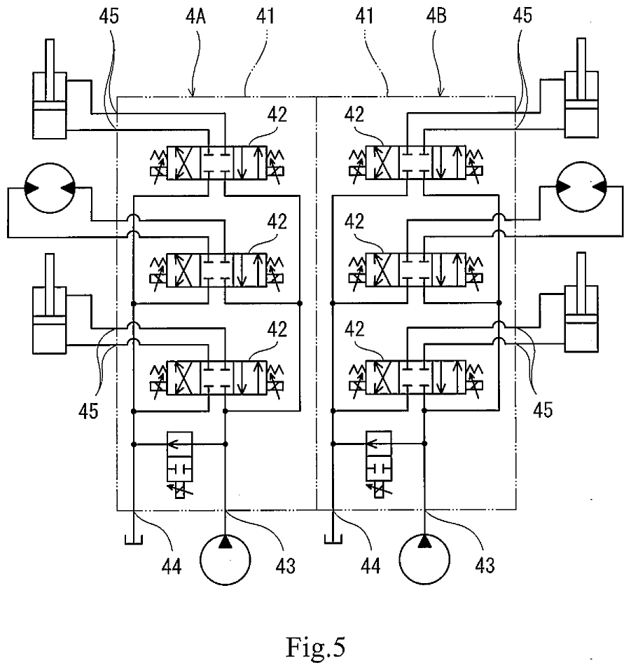

In the present embodiment, as shown in FIG. 5, each of the first apparatus 4A and the second apparatus 4B is a multi-control valve that incorporates therein a plurality of spools 42, each of which changes a passing flow rate thereof in accordance with a command current.

Specifically, the first apparatus 4A and the second apparatus 4B include their respective casings 41, which are independent of each other. Each casing 41 is, for example, a hexahedron having six side surfaces. One side surface of the casing 41 of the first apparatus 4A and one side surface of the casing 21 of the second apparatus 4B are in surface contact with each other.

As shown in FIG. 5, each spool 42 controls the amount of hydraulic liquid supplied from a hydraulic pump to a hydraulic actuator and the amount of hydraulic liquid discharged from the hydraulic actuator to a tank. The hydraulic actuator may be a hydraulic cylinder, or may be a hydraulic pump.

The casing 41 of each of the first apparatus 4A and the second apparatus 4B incorporates therein the same number of pairs of driving mechanisms as the number of spools 42. Each pair of driving mechanisms moves a corresponding one of the spools 42 in one or the other direction in accordance with the command current. In each pair of driving mechanisms, each driving mechanism may be a solenoid proportional valve that outputs a secondary pressure as a pilot pressure to the corresponding spool 42. Alternatively, in each pair of driving mechanisms, each driving mechanism may be a solenoid that presses the corresponding spool 42.

One side surface of the casing 41 of each of the first apparatus 4A and the second apparatus 4B (in FIG. 3, the bottom surface) is provided with a pump port 43 and a tank port 44 (see FIG. 5). Also, two side surfaces of the casing 41 of each of the first apparatus 4A and the second apparatus 4B (in FIG. 3, the right side surface and the left side surface) are each provided with a plurality of actuator ports 45. It should be noted that the hydraulic circuit and the number of actuator ports 45 shown in FIG. 5 can be changed as necessary.

As shown in FIG. 3, a first storage medium 33 and a second storage medium 34 are attached to one side surface of the casing 41 of the first apparatus 4A (in FIG. 1, the front surface), such that the first storage medium 33 and the second storage medium 34 are adjacent to each other. Alternatively, the first storage medium 33 and the second storage medium 34 may be attached to one side surface of the casing 41 of the second apparatus 4B, such that the first storage medium 33 and the second storage medium 34 are adjacent to each other.

In the present embodiment, characteristic data of the first apparatus 4A is stored on the first storage medium 33 in the form of a bar code, and characteristic data of the second apparatus 4B is stored on the second storage medium 34 in the form of a bar code. For example, the bar code is a matrix two-dimensional code (QR code (registered trademark)).

In the present embodiment, the first storage medium 33 and the second storage medium 34 are separate from each other. Alternatively, the first storage medium 33 and the second storage medium 34 may be integrated together. In this case, a single object can be used as the two storage media 33 and 34.

Each of the first storage medium 33 and the second storage medium 34 may be attached to the casing 41, for example, by affixing using an adhesive or a double sided tape, or by screw fixing.

As shown in FIG. 4, the characteristic data of each of the first apparatus 4A and the second apparatus 4B are relationships between the command current and the passing flow rates of the respective spools 42. The command current-passing flow rate relationship exists for each moving direction of each spool 42. The passing flow rate is either one of the following two kinds of passing flow rates: a meter-in passing flow rate; and a meter-out passing flow rate.

The characteristic data is discrete data as represented by a plurality of points in FIG. 4, and the characteristic data of each apparatus (4A or 4B) is measured at a factory before its shipping from the factory. Also, when the apparatus is repaired (e.g., when a component of the apparatus is replaced), the characteristic data of the apparatus is re-measured.

Each of the first storage medium 33 and the second storage medium 34 stores the date of the measurement of the characteristic data of the corresponding apparatus (4A or 4B) in a visually recognizable manner. Each of the first storage medium 33 and the second storage medium 34 further stores identification data (individual product number) of the corresponding apparatus (4A or 4B).

The apparatus unit 1B is installed, for example, in a construction machine (e.g., a hydraulic excavator or a hydraulic crane) or in an industrial machine. The first apparatus 4A and the second apparatus 4B are controlled by a controller of the machine. For example, the controller feeds the command current to each pair of driving mechanisms of the first apparatus 4A and each pair of driving mechanisms of the second apparatus 4B in accordance with an operation amount of an operation device operated by a user.

The characteristic data of the first apparatus 4A, which is stored on the first storage medium 33, and the characteristic data of the second apparatus 4B, which is stored on the second storage medium 34, are read by a bar code reader and inputted to the aforementioned controller of the machine. The controller electronically calibrates variation in characteristics between the first apparatus 4A and the second apparatus 4B. For example, the controller adjusts the command current fed to each pair of driving mechanisms of the first apparatus 4A and each pair of driving mechanisms of the second apparatus 4B so that a preset passing flow rate corresponding to an operation amount of the operation device operated by the user will be obtained.

As described above, in the apparatus unit 1B of the present embodiment, the characteristic data of the first apparatus 4A is stored on the first storage medium 33, and the characteristic data of the second apparatus 4B is stored on the second storage medium 34. Therefore, the characteristic data of the first apparatus 4A and the characteristic data of the second apparatus 4B can be read directly. In addition, since the first storage medium 33 and the second storage medium 34 are attached to one side surface of the casing of the first apparatus 4A such that the first storage medium 33 and the second storage medium 34 are adjacent to each other, the characteristic data of the first apparatus 4A and the characteristic data of the second apparatus 4B can be read efficiently within a short period of time.

Moreover, in the present embodiment, each storage medium (33 or 34) stores the date of the measurement of the characteristic data of the corresponding apparatus (4A or 4B) in a visually recognizable manner. Therefore, the user can recognize the repair history of the apparatus by looking at the storage medium. This improves the maintainability at a work site.

### Other Embodiments

The present invention is not limited to the above-described embodiments. Various modifications can be made without departing from the scope of the present invention.

For example, in Embodiment 1, each storage medium (31 or 32) stores the characteristic data of the corresponding apparatus (2A or 2B). However, instead, the characteristic data of the first apparatus 2A and the characteristic data of the second apparatus 2B can be saved in, for example, a server or a terminal, and the IP address of the save location of the characteristic data of the first apparatus 2A can be stored on the first storage medium 31, whereas the IP address of the save location of the characteristic data of the second apparatus 2B can be stored on the second storage medium 32. In this case, the IP address of the save location may be stored on each storage medium not necessarily by attaching a bar code thereto, but, for example, by printing the IP address on each storage medium.

The above configuration makes it possible to read the characteristic data of each apparatus via the Internet. Moreover, the above configuration makes it possible to save a large amount of characteristic data in a server or a terminal. Therefore, variation in characteristics between the apparatuses can be calibrated precisely. It should be noted that the above-described variation in which the IP address of the save location of the characteristic data is stored on the storage medium is applicable also to Embodiment 2.

### REFERENCE SIGNS LIST

1A, 1B apparatus unit

2A, 2B apparatus

21 casing

4A, 4B apparatus

41 casing

31 to 34 storage medium

1. An apparatus unit comprising two or more apparatuses coupled to each other, the apparatuses including respective casings that are independent of each other, wherein
two or more storage media are attached to one side surface of the casing of one of the two or more apparatuses such that the two or more storage media are adjacent to each other, the two or more storage media each storing characteristic data of a corresponding one of the two or more apparatuses or storing an IP address of a save location of the characteristic data of the corresponding one of the two or more apparatuses.

2. The apparatus unit according to claim 1, wherein
each of the two or more apparatuses is a pump whose delivery flow rate changes in accordance with a command current, and
the characteristic data of each apparatus is a relationship between the command current and the delivery flow rate at a particular delivery pressure.

3. The apparatus unit according to claim 2, wherein
the particular delivery pressure is each of two different delivery pressures.

4. The apparatus unit according to claim 1, wherein
each of the two or more apparatuses is a multi-control valve that incorporates therein a plurality of spools, each of which changes a passing flow rate thereof in accordance with a command current, and
the characteristic data of each apparatus are relationships between the command current and the passing flow rates of the plurality of respective spools.

5. The apparatus unit according to claim 1, wherein
each of the two or more storage media further stores a date of measurement of the characteristic data of the corresponding apparatus in a visually recognizable manner.

6. The apparatus unit according to claim 1, wherein
the two or more storage media are integrated together.

7. The apparatus unit according to claim 2, wherein
each of the two or more storage media further stores a date of measurement of the characteristic data of the corresponding apparatus in a visually recognizable manner.

8. The apparatus unit according to claim 3, wherein
each of the two or more storage media further stores a date of measurement of the characteristic data of the corresponding apparatus in a visually recognizable manner.

9. The apparatus unit according to claim 4, wherein
each of the two or more storage media further stores a date of measurement of the characteristic data of the corresponding apparatus in a visually recognizable manner.

10. The apparatus unit according to claim 2, wherein
the two or more storage media are integrated together.

11. The apparatus unit according to claim 3, wherein
the two or more storage media are integrated together.

12. The apparatus unit according to claim 4, wherein
the two or more storage media are integrated together.

13. The apparatus unit according to claim 5, wherein
the two or more storage media are integrated together.

14. The apparatus unit according to claim 7, wherein
the two or more storage media are integrated together.

15. The apparatus unit according to claim 8, wherein
the two or more storage media are integrated together.

16. The apparatus unit according to claim 9, wherein
the two or more storage media are integrated together.
